(19) United States
(12) Patent Application Publication
(10) Pub. No.: US 2013/0241832 A1
(43) Pub. Date: Sep. 19, 2013

(54) METHOD AND DEVICE FOR CONTROLLING THE BEHAVIOR OF VIRTUAL OBJECTS ON A DISPLAY

(71) Applicants: Ori Rimon, Tel Aviv (IL); Rafi Zachut, Rishon Le'zion (IL)

(72) Inventors: Ori Rimon, Tel Aviv (IL); Rafi Zachut, Rishon Le'zion (IL)

(73) Assignee: ZRRO TECHNOLOGIES (2009) LTD., Tel Aviv (IL)

(21) Appl. No.: 13/821,444

(22) PCT Filed: Sep. 7, 2011
(86) PCT No.: PCT/IL2011/000715

§ 371 Date: May 24, 2013

Related U.S. Application Data
(60) Provisional application No. 61/380,406, filed on Sep. 7, 2010.

(51) Int. Cl. G06F 3/0354

(52) U.S. Cl. CPC G06F 3/03547
USPC 345/158

(57) ABSTRACT

A method for use in controlling images on a screen, including identifying each object from some objects with respect to a sensing surface, and assigning a dedicated image to that object for presentation on a screen, sensing behavior of that object by monitoring its position contacting the sensing surface and generating position data indicative thereof, and selectively identifying a break in contact between the contacting object and the sensing surface and generating data indicative thereof, processing the position data and generating transformation data between the coordinate system of the sensing surface and a virtual coordinate system of the screen, and selectively generating and storing data indicative of a last position in the virtual coordinate system of an image corresponding to a contacting object, when the contacting object breaks contact with the sensing surface; and using the transformation data for controlling the image associated with each contacting object on the screen.

### FIELD OF THE INVENTION

This invention relates to a device and method for controlling the behavior of virtual objects, and more particularly but not exclusively to a device and method for manipulating the motion of cursors on a screen.

### BACKGROUND OF THE INVENTION

Various pointing utilities (e.g., touchpad or track-pad or touch screen or mouse) are commonly used to detect the position and motion of a physical object, e.g. a user's finger or hand, and translate it to a cursor position on a screen. For example, a touch-pad is a pointing device that can translate the motion and position of a user's finger, touching the touchpad's surface, to a relative position on a screen which is used to manipulate a cursor on the screen, e.g., moving the finger across the touchpad's surface will result in the cursor's movement across the display screen. Touchpad or mouse is a common component used in computers, especially portable computers, such as laptop computers.

### GENERAL DESCRIPTION

The present invention provides a novel technique for use in a motion tracking device such as a touchpad but allows for controlling more than one virtual object. In this connection, it should be noted that at present, control of more than one cursor motion in indirect fashion (i.e. without touch screen) can be achieved by concurrently using several pointing devices such as mouse, touchpad and stylus.

According to the invention, there is provided a monitoring system for simultaneously monitoring the behavior of multiple physical objects (at least two objects. e.g. fingers), and make use of this monitoring to control the motion of virtual objects (images), such as cursors on a screen of a computer device. The latter may be a phone device, PDA, TV screen or the like. The monitoring system of the present invention comprises a motion sensing device, a processor utility, and display device, which may be integral in a portable electronic device, or may be incorporated in separate units. For example, the physical objects' behavior may be monitored remotely from the virtual object's location, i.e. the motion behavior is presented on a device located remotely from a sensing device. An example of such a remote monitoring is described in WO 2010/084498 assigned to the assignee of the present application, which is incorporated herein by reference.

The sensing device used in the system of the present invention is configured as a proximity sensor capable of determining the physical object's position in a coordinate system defined by a (planar or not) sensing surface (touching or contacting object condition) and optionally also detecting existence of the object in a vicinity of the sensing surface (a three-dimensional space) outside thereof (hovering object condition). To this end, the sensing surface may be defined by a matrix of sensors, such as capacitive sensor matrix, acoustic sensor matrix, electro-magnetic sensor (e.g. infrared sensor that can actually measure temperatures of a human body regardless of ambient light level, i.e. even in total darkness; microwave sensor; RF sensor; optical or electro-optical sensor in which case an ambient light generator is used to enable sensor operation in darkness). Additionally, an optical sensor may be used together with the contact-type sensor matrix, for identifying existence of a hovering object in the vicinity of the sensing surface. Construction and operation of such proximity sensor matrix are known per se and therefore need not be described in details, except to note that the may be the so-called “active” or “passive” sensor. For example, active-type capacitive proximity sensor generates an electric field in the vicinity of the sensor, and when a physical object approaches the sensor (its sensing surface) it effects a change in the electric field which is detected being indicative of the location of the object relative to the sensor. The passive capacitive proximity sensor does not utilize generation of the electric field but rather is sensitive to a change in an external electric field (due to the object's relative position) in the vicinity thereof.

Thus, the invention provides a monitoring system comprising a sensor device and a control unit, and is associated with a display device. The control unit includes inter alia a processor utility configured and operable for receiving position data from the sensor device about a contacting object, and calculating the virtual object's behavior (i.e. motion of the corresponding images on the display) for every object from a plurality of objects (generally, at least two objects). The processor utility is also capable of identifying a break in contact between the object and the sensing surface, and operating the sensor device to perform a second sensing mode for detecting the object hovering above the sensing surface. In this case, the processor utility operates to store a last position of said object in the sensing surface before the break of contact between them. This last-position data is used for defining a position of the respective image (cursor) on the screen for a next contact between the same object and the sensing surface.

The processor utility thus includes an identifier utility, which continuously measures the object's position along the sensing surface of the sensor device, and upon detecting a break in contact between the object and sensing surface (i.e. detecting that the object goes out of the sensing surface or “disappears from the 2D field of view of the sensor device), appropriately interprets the next contact detection event. For example, if the processor utility identifies a continuous motion of a first object through and out of the sensing surface, its next contact detection event is identified as that of the first object,

Control of the virtual object's behavior (image motion on the screen) is based on transformation of physical object's position in a first (physical) coordinate system of the sensor device defined by its sensing surface into a second (virtual) coordinate system (which is typically 2D system) of the screen. The transformation used in this technique is a so-called “relative” transformation. In a relative transformation, a map is used presenting a relation between at least some of the positions/motions in the first coordinate system and at least some of the virtual positions in the virtual coordinate system. Such map is redefined each time the object is not tracked by the sensor device (i.e. goes out of the sensing volume).

For example, considering the conventional touchpad, the user's finger (the object) is tracked by the touchpad as long as the finger is in contact with the touchpad's sensing surface. Before the user's finger touches the touchpad's sensing surface, the cursor is initially at a first virtual position on the screen (virtual coordinate system). When the user's finger is brought into contact with the touchpad's sensing surface, the position of the finger along the touchpad's sensing surface (the first coordinate system) is made to correspond to the cursor's initial virtual position, and a first map is built accordingly. As long as the user's finger is in contact with the touchpad's sensing surface, the movement of the finger corresponds to a movement of the cursor on the displayed scene, calculated according to the parameters of the first map. Thus, after the movement, a second position of the finger along the touchpad's sensing surface corresponds to a second position of the cursor in the displayed scene. When the finger is lifted off the touchpad's surface, a memory utility associated with the touchpad stores the last virtual position of the cursor before contact is lost (in this case, the second virtual position). When the finger comes back in contact with the touchpad's sensing surface at a third position, a second map is created, in which the finger's third position along the sensing surface is made to correspond to the cursor's second virtual position (i.e. the last virtual position of the cursor before contact is lost).

Since a conventional touchpad supports one physical object only, the assignment of physical object to virtual object is clear, when the object returns to touch the touch pad, but when there are multiple physical object which control multiple virtual object, and some physical object are in non-touch state together, there is a problem to keep the original assignment of physical object to its correspondent virtual object when it returns to touch state.

The technique of the present invention advantageously provides for using the so-called relative pointing utilities, such as touchpads, or mice, which are very popular. Users are therefore accustomed to using relative tracking utilities. Such a technique would enable the users to use tracking utilities configured for tracking at least two objects simultaneously, while using familiar motions that are typically associated with the use of relative tracking utilities. To this end, the present invention utilizes a touchpad-like sensor device and a processor utility capable of identifying the object's disappearance from the sensing surface and identifying and managing transformation for the further detected contact event. Such identifying and management is needed when dealing with simultaneous device operation by multiple virtual objects. In some embodiments of the present invention, the touch-pad sensor is modified (e.g. comprising a proximity sensor matrix) to be capable of object detection (not necessarily exact position detection) in a 3D space in the vicinity of a sensing surface (e.g. capacitive proximity sensor may be used for both purposes). As will explained, monitoring the physical object in 3D space enables to keep the assignment of physical objects to their corresponding virtual objects (images), even when the physical objects do not touch the touch-pad like sensor.

Thus, the present invention relates to a technique for monitoring object's behavior capable of concurrently operating with multiple (at least two) objects interacting with a sensor device (i.e. touching a sensing surface and hovering thereabove), and transforming data indicative of the touching conditions into the behavior of their corresponding virtual objects in a virtual 2D coordinate system.

Some exemplary aspects of the disclosure include apparatuses and methods for manipulating and/or operating more than one cursor, and more particularly but not exclusively to a device and method for manipulating and/or operating more than one cursor on a display screen associated with a touchpad-like device modified for the purposes of the present invention.

Some exemplary aspects of the invention may be directed to a device and a method for manipulating and/or operating and/or controlling motion of more than one cursor on a display screen. The display screen may be a computer's display, a laptop's display, a TV etc. The cursors may be manipulated and/or controlled by one or more user's fingers via a proximity sensor device, e.g. a touchpad with a 3D capability.

In some embodiments, a touching and/or a hovering finger (e.g., a hovering finger may be placed and/or moved in proximity to or in the vicinity of the sensing surface) may be detected by the sensing surface. A hovering finger over the sensing (detection) surface may be detected within a 3D sensitivity zone of the sensor device (above the sensing/detection surface), e.g. in a distance in the range of 0-5 cm, 0-10 cm, e.g. 1, 2, 5 or 8 cm. Generally, for the purposes of the present invention, there is no need for measuring such distance and detecting z-axis position of the object, but rather detecting a shift of the previously identified object from contact condition to hovering condition by detecting existence of said object in the 3D sensitivity zone. However, it should be understood that the sensing matrix used in the system might be capable of detecting a distance above the sensing surface (e.g., height) of each finger, e.g. an accurate or substantially accurate height for each finger may be determined. However, recording such measured data and transformation thereof into virtual coordinate system might not be performed. In some embodiments, one or more fingers touching a detection surface and one or more fingers hovering over the detection surface may be detected and/or tracked simultaneously.

In some embodiments, a cursor is assigned to each finger touching or hovering over the sensing surface. Such an assignment is actually performed by the identifier utility of the processor in an identification mode thereof. The identification may be performed by processing measured data of the sensor device indicative of the object's position on the sensing surface (touch sensing) and/or position in 3D space in the vicinity of the sensing surface. Each of the objects is therefore assigned its own ID.

According to a non-limiting example, the identification of the object is made by receiving data generated by a proximity sensor and processing such data according to an “object independent” processing scheme using the HMM (Hidden Markov Model) or “an object dependent” processing scheme utilizing a learning session of features values of the specific user whose behavior is being monitored.

Another known suitable heuristic (used in “particles tracking”) for “object independent” identification processing is based on matching between previous histories of objects to new positions found, according to the principle of minimum sum of distances. For example, let PA and PB be the last points in the histories of fingers A and B. and let P1 and P2 be the positions currently found. Then, if the following condition is satisfied

distance(PA,P1)+distance(PB,P2)<distance(PA,P2)+distance(PB,P1)

then P1 is added to the history of finger A and P2 is added to the history of finger B, otherwise P1 is added to the history of finger B and P2 is added to the history of finger A.

Thus, in some embodiments, the movement of touching fingers on the sensing surface may be tracked. The cursor may be manipulated and/or controlled in accordance with the movement of corresponding touching finger, e.g., cursor A is assigned to finger A and is manipulated (e.g., moves) on the display screen in accordance with a movement of finger A on the sensing surface. To this end, the position of the fingers in a first coordinate system (e.g., which corresponds to the coordinate system of the sensing surface) is translated to a position of the cursor in a second coordinate system (e.g., which corresponds to the coordinate system of the display screen).

Typically, the area and/or size of the sensing surface may be smaller than an area or size of the display screen. A touching finger (to which a cursor is assigned) may be lifted and/or raised from the sensing surface, thus becoming a hovering finger. The last position of the touching finger (before it was lifted) is recorded and stored, e.g., in a memory. The cursor may be displayed in the last position until the hovering finger (that was previously a touching finger) re-touches the sensing surface and moves. Optionally, the cursor may be displayed in the last position for a pre-determined time, for example, in the range of 1-5 min, 1-10 min, e.g., 3, 5, 7 min. In some embodiments, the cursor may be displayed in the last position in a different manner and/or fashion than a cursor that is being manipulated by a corresponding touching finger.

The hovering finger (that was previously a touching finger) may be tracked when hovering over the sensing surface and when re-touching the sensing surface may be assigned with the same previous corresponding cursor. In some embodiments, finger hovering over the sensing surface below a pre-defined distance (relative to the sensing surface), e.g., 2, 3, 4 cm, may be tracked and when re-touching the sensing surface may be assigned with the same previous corresponding cursor. Typically, the same previous corresponding cursor may be assigned and/or displayed in the last position that was stored (recorded) for that cursor.

For example, cursor A is assigned to finger A and is manipulated (e.g., moves) on the display screen in accordance with a movement of finger A on the sensing surface. When finger A is lifted from the sensing surface and hovers above the sensing surface, the last position of cursor A is stored and hovering finger A is still being tracked. When finger A re-touches the sensing surface, cursor A is still displayed in the stored last position and is now manipulated in accordance with the movement of finger A on the sensing surface.

In some embodiments, the record of the last position of a cursor may be deleted when the corresponding finger (of that cursor) is no longer detected by the sensing (detection) surface (e.g., no longer tracked), for example when the finger is placed in a position that the sensing surface is unable to detect, e.g., when the finger is placed above the sensing surface in a distance above 20 cm for example. In some embodiments, when a hovering finger is no longer tracked, the corresponding cursor is no longer assigned to that finger. In some embodiments, when a hovering finger is no longer tracked, the corresponding cursor is no longer displayed.

In some embodiments, a maximum number N of objects, e.g. fingers, operable and/or allowable and/or permitted to interact with a sensing surface, is determined. The maximum number of fingers (N) may be system defined or user defined. For example, the maximum number of fingers (N) may be in the range of 2-10, e.g. 2, 3, or 4. The maximum number of fingers (N) corresponds to a maximum number of cursors (N) which are assigned to the fingers respectively.

In some embodiments, during operation, at least N−1 fingers are touching (e.g., interacting with) the sensing surface and corresponding cursors (at least N−1) are manipulated in accordance with a movement of corresponding fingers on the sensing device. During operation, when N fingers are touching the sensing surface and corresponding N cursors are manipulated, one finger may be lifted from the sensing surface, and its last position may be recorded and/or stored, e.g., in a memory. The hovering finger may or may not be tracked when hovering above the sensing surface. During operation, when N−1 fingers are touching the sensing surface and corresponding N−1 cursors are manipulated, an additional finger may touch the sensing surface and a corresponding cursor may be assigned to the additional finger in the last position that is recorded and/or stored, e.g., in a memory.

In some embodiments, a different icon and/or image (e.g., an arrow image) may be associated with each different cursor. The user may be able to select and/or choose the different icon and/or image associated with the different cursor. For example, detecting the presence of a finger touching or hovering above the sensing surface may invoke appearance of a selection box on a display including a plurality of icons and/or images from which the user may be able to select an icon or image for the cursor. In some embodiments, a different color may be associated with each different cursor (e.g., the image associated with each different cursor may be identical but colored differently).

It should be understood that the terms ‘sensing surface’ and ‘detection surface’, as used herein, may refer to a sensing surface (being planar or curved) of any suitable sensor device configured to detect at least one user interaction, e.g., user's finger, stylus, etc., in a contact fashion and possibly in a contactless fashion as well. The detection surface may be transparent (e.g., when a touch screen is used to manipulate cursors on a remotely located display screen, for example a mobile phone having a touch screen may be used to manipulate cursors on a TV screen) or semi-transparent or non-transparent (e.g., when used as a touchpad). The user interactions may be detected while touching the detection surface or hovering above the detection surface (e.g., a finger may be placed and/or moved in proximity to or in the vicinity of the detection surface). The ‘detection/sensing surface’ may detect a presence and/or a position of a user interaction on and/or above the detection/sensing surface (within the detection/sensing zone). As indicated above, the sensor device may be configured to measure a distance above the sensing surface (e.g., height) for each finger. As indicated above, user interaction with the sensor device may be detected by any technology known in the art, e.g. capacitive, resistive, surface acoustic waves (SAW), Infrared, Optical imaging etc. The detection surface may be configured to detect simultaneously more than one interaction on and/or above the detection surface, for example, more than one user's finger, e.g., multi-touch. The detection surface may be that of a touch pad (e.g., a capacitive touch sensing pad) or a plurality of touch pads (e.g., arranged in a matrix shape), etc., equipped with a 3D detection utility.

It should also be noted that the term ‘cursor’, as used herein, refers to any indicator or pointer or sign on a display screen, e.g., a computer's screen. The cursor may be manipulated and/or controlled on the display screen in accordance with a user interaction, e.g., moving a finger on a touch pad. The cursor may be displayed with an icon and/or image on the display screen, e.g., an arrow shaped cursor.

Thus, according to one broad aspect of the invention, there is provided a method for use in controlling images on a screen, the method comprising:

identifying each object from certain number of objects with respect to a sensing surface, and assigning a dedicated image to the identified object for presentation on a screen;

sensing behavior of the object, said sensing comprising: monitoring a position of the object contacting the sensing surface and generating position data indicative thereof, and selectively identifying a break in contact between said contacting object and the sensing surface and generating data indicative thereof;

processing the position data for the contacting object and generating transformation data between the first coordinate system of the sensing surface and a virtual coordinate system of the screen, and selectively generating and storing data indicative of a last position in the virtual coordinate system of one or more images corresponding to one or more contacting objects, when said one or more contacting objects break contact with the sensing surface;

using said transformation data for controlling the image associated with each contacting object on the screen.

Optionally, said certain number of objects is more than one. In a variant, the objects are fingers of user's hand. In another variant, the objects are fingers of one or two hands of a user.

According to some embodiments of the present invention, said sensing comprises detecting a hovering object, that has broken contact with the sensing surface, in a vicinity of the sensing surface; and said controlling comprises manipulating the image associated with the hovering object from the last position, when the hovering object re-touches the sensing surface.

Optionally, the above method comprises monitoring a movement of each user's finger from a plurality of fingers touching the sensing surface and controlling movement of each of a plurality of corresponding images on the screen in accordance with the fingers' movement.

Said sensing may carried out substantially simultaneously for multiple identified objects.

Another aspect of the present invention relates to a method for controlling a plurality of images on a screen corresponding to a plurality of objects, the method comprising:

identifying each object with respect to a sensing surface, and assigning thereto a dedicated image for presentation on a screen;

sensing each object with respect to the sensing surface, said sensing comprising determining position of each object touching the sensing surface in a first coordinate system of the sensing surface and generating position data indicative thereof, and selectively detecting a hovering object in a vicinity of the sensing surface and generating data indicative thereof;

substantially simultaneously sensing behavior of at least two objects with respect to the sensing surface, said sensing comprising: monitoring a position of the object contacting the sensing surface in a first coordinate system of the sensing surface and generating position data indicative thereof; selectively detecting a hovering object in a vicinity of the sensing surface and generating data indicative thereof when a break in contact between said contacting object and the sensing surface occurs,

processing and analyzing the position data for the contacting objects and generating transformation data between a first coordinate system of the sensing surface and a virtual coordinate system of the screen, and selectively generating and storing data indicative of a last position in the virtual coordinate system of one or more images corresponding to one or more contacting objects, when said one or more contacting objects break contact with the sensing surface; and

using said transformation data for manipulating images on the screen for each of the contacting objects.

Another aspect of some embodiments of the present invention relates to a system for monitoring object's behavior, the system comprising:

a sensor device, the sensor device being configured and operable to carry out a first sensing mode to determine an object's position in a first coordinate system of the sensor device, for each object in a certain number of objects touching a sensing surface of said sensor device, and generate first position data indicative of a position of the touching object in said first coordinate system, said sensor device being configured and operable to selectively carry out a second sensing mode to detect a hovering object in a vicinity of the sensing surface and generate second data indicative thereof;

a control unit comprising:
an identifier utility configured and operable for carrying out the following: identifying each object with respect to the sensing surface, and assigning a dedicated image to the identified object for presentation on a screen; analyzing the first and second data generated by the sensor device and identifying a break in contact between said contacting object and the sensing surface;
a transformation utility configured and operable for processing the position data for the contacting objects and generating transformation data between a first coordinate system of the sensing surface and a virtual coordinate system of the screen, thereby enabling to use said transformation data for controlling images on the screen for each of the contacting objects, said transformation of the position data including data indicative of a last position for the hovering object in the virtual coordinate system before the contact break with the sensing surface.

In a variant, said sensing device comprises a single proximity sensing unit defining the sensing surface and configured and operable for carrying out both the first and the second sensing.

In another variant, wherein said sensing device comprises a first sensing unit defining the sensing surface and configured and operable for detecting objects touching said sensing surface, and a second sensing unit configured and operable for detecting at least hovering objects.

The sensing surface may be selected from the following: a capacitive sensing surface, a resistive sensing surface, a surface acoustic waves sensing surface, and an optical sensing surface.

According to some embodiments of the present invention, the above system further comprises a screen device defining a virtual coordinate system and configured and operable for receiving the transformation data and presenting the images of the objects.

According to another aspect of the present invention, there is provided a control system for controlling multiple images on a screen each image corresponding to a remote object, the system comprising:

a plurality of monitoring units each comprising the above-described monitoring system; and

a common screen device defining the virtual coordinate system and connectable to each of the monitoring units and configured and operable for receiving the transformation data from the monitoring unit indicative of behavior of one or more remote objects and presenting the corresponding images.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 illustrates a block diagram of a monitoring system according to the invention for use in simultaneously controlling behavior of multiple virtual objects;

FIG. 2 exemplifies a portable electronic device incorporating the monitoring system of FIG. 1;

FIG. 3 exemplifies an electronic device incorporating the monitoring system of FIG. 1 and configured for manipulating behavior of multiple virtual objects remotely from the corresponding physical objects' locations;

FIGS. 4A and 4B illustrate flowcharts for two examples, respectively, of a method of the invention for monitoring multiple objects' behavior;

FIG. 5 exemplifies a plurality of cursors manipulated on a computer's display in accordance with an example the present invention;

FIG. 6 is a simplified flow chart describing an exemplary method for manipulating and/or controlling a plurality of cursors on a display screen in accordance with some embodiments of the present invention;

FIG. 7 is a flowchart illustrating a first example of a method for monitoring the behavior of a plurality of object simultaneously;

FIG. 8 is a flowchart illustrating a second example of a method for monitoring the behavior of a plurality of object simultaneously; and

FIG. 9 is a flowchart describing a method for monitoring the behavior of a plurality of objects simultaneously with some embodiments of the present invention, by using a sensor capable of detecting object via a single detection technique.

### DETAILED DESCRIPTION OF EMBODIMENTS

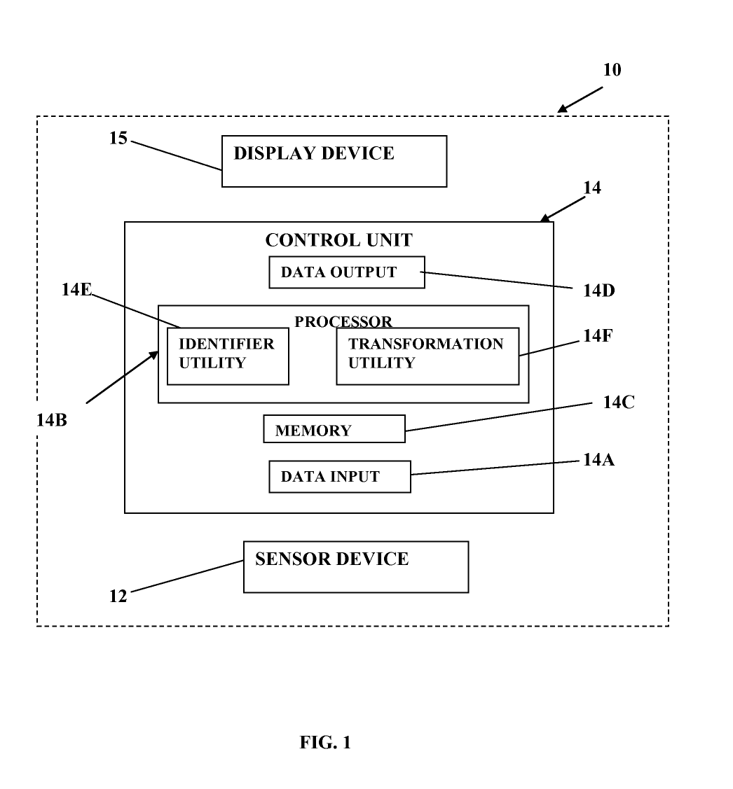

Reference is made to FIG. 1 which illustrates a block diagram of a system 10 of the present invention configured and operable for simultaneously controlling behavior of multiple virtual objects. In should be noted, and will be described further below that in some embodiments, the constructional parts of the system may be appropriately distributed between separate devices enabling controlling of the virtual objects' behavior remotely from the physical objects' location, or may be integral in the same device, e.g. portable device.

System 10 includes a sensor device 12 configured and operable for determining position of an object in a first coordinate system defined by a sensing surface of the sensor device 12 and generating measured data indicative thereof, a control unit 14 configured and operable for receiving measured data and transforming it into corresponding position data in a different coordinate system in which a corresponding image is to be displayed. The system 10 is associated with (i.e. includes or is connectable to) a display device 15. The control unit 14 may be integral with the sensor device 12, or with the display device 15, or may be a separate unit, or its functional utilities may be distributed within the display and sensor devices, as the case may be. It should be noted, although not specifically shown, that the present invention may utilize multiple independent (separate) monitoring units, each including the monitoring system 10, and all being associated with the common display device 15.

The sensor device may be of any known suitable type, for example including a proximity sensor matrix defining a contact sensing zone, and optionally an additional 3D hover sensing zone, and capable of detecting object's position within the contact sensing zone (the sensor's sensitivity zone or “field of view”). Measured data generated by the sensor device is indicative of the behavior (motion) of an object in a first coordinate system associated with the sensing surface of the sensor matrix. The object can be associated with at least a portion of a user's hand or finger, or multiplicity of fingers. The sensor matrix may include an array (one- or two-dimensional array) or generally a spatial arrangement of a plurality of spaced-apart contact or proximity sensors. Typically, a sensor matrix may include sensors arranged in row and column configuration including m rows and n columns within a sensing plane or curved surface defined by a substrate supporting the matrix or a single monolithic piece in which the matrix is embedded. The arrangement of sensors defines a sensing surface and the position detection ability of the sensors defines the first coordinate system for detection of the behavior of an object touching the sensing surface.

In some embodiments of the present invention, the sensor device is also configured and operable for detecting a presence of one or more objects hovering over the sensing surface. This is done for tracking the previously identified object when there is no contact between the object and the sensing surface. While no accurate measurement of the distance between the sensing surface and the object is necessary, the sensor device may be able to measure such distance between the object and the sensing surface (height or z-axis position) in a contactless sensing mode. In some embodiments, the sensor device is a proximity sensor capable of both sensing objects contacting the sensing surface and hovering over the sensing surface. In some embodiments, the sensing device includes a contact-type sensor unit (such as a touchpad) for detecting the position of object(s) touching the contact-type sensor unit, and a three dimensional sensing unit, for sensing the object(s) even when he object(s) are not touching the contact-type sensor unit. The three dimensional sensing unit may be, for example, a proximity sensor, or an optical sensor (camera or array of cameras), located either near the contact-type sensor unit or at a remote position with respect to the contact-type sensor unit. If the three dimensional sensing unit is an optical sensor, the monitoring of the object(s) is performed via image processing and computer vision methods known in the art. The sensor device may operate in a continuous measurement mode or with a certain sampling mode.

As indicated above, the proximity sensor matrix may utilize capacitive proximity sensors, the construction and operation of which are known per se. The use of such proximity sensor matrix in a system for monitoring behavior of an object is exemplified in the above-indicated WO 2010/084498 which is assigned to the assignee of the present application, and which is incorporated herein by reference.

The control unit 14 includes inter alia such functional modules (software and/or hardware utilities) as data input utility 14A connectable to the output of the sensor device, processor utility 14B, memory 14C, and data output utility 14D connectable to the display device. The processor utility 14B includes an identifier module 14E and a transformation module 14F.

The identifier module 14E is configured and operable to be responsive to the measured position data from the sensor device 12 for selectively operating in its assigning mode in which it assigns an image (cursor/item/sign) for an object being sensed and in an identification mode in which it identifies a condition of the object with respect to the sensing zone. The identifier module 14E, when in the identification mode thereof, determines whether the object being sensed in a current event is a “touching” or “contacting” object and whether said object has broken contact with the sensing surface of the sensor device 12. Optionally, the identifier module 14E may further determine (in response to data from the sensor device) whether the object is a “hovering” object. Such decision may be made, for example, according to the Z-axis value associated with the object's position data (i.e. a distance between the sensing surface and the object). If the “touching” condition of the object is identified, the identifier module 14E generates identification data indicative of the object's position as measured by the sensor device. Upon identifying the contact break of the object, the identifier 14E may generate data indicative thereof to enable the transformation utility to transform measured data indicative of the last position of the contacting object (before the contact break) into a position of the image in the virtual coordinate system (e.g. that of the screen).

The transformation module 14F is responsive to identification data from the identifier 14E and processes the corresponding sensed data to transform it into the virtual object position in the coordinate system of the display device. The latter operates accordingly to display the object-related image on the screen. For this purpose, when identifier module 14E identifies the break of contact (and possibly stops data generation for an object due to contact break), transformation module 14F saves the last location of the corresponding image in the virtual coordinate system.

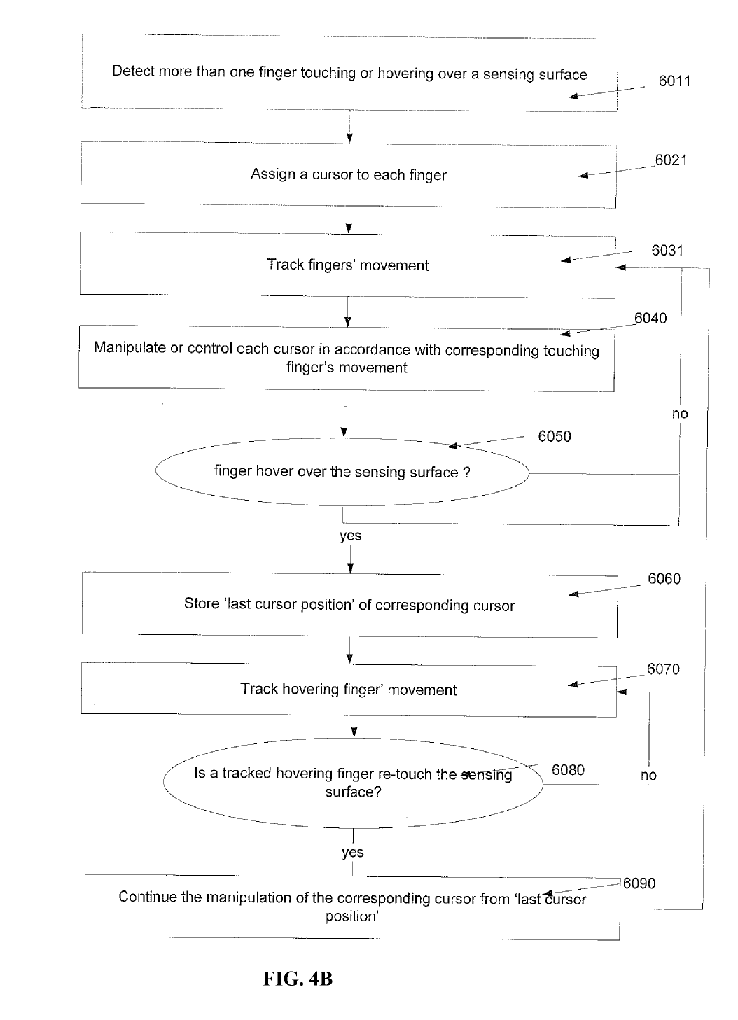

Depending on the type of sensor device used, the control unit 14 may operate according to the methods described in the examples of FIGS. 4A-4B, 6-9 below.

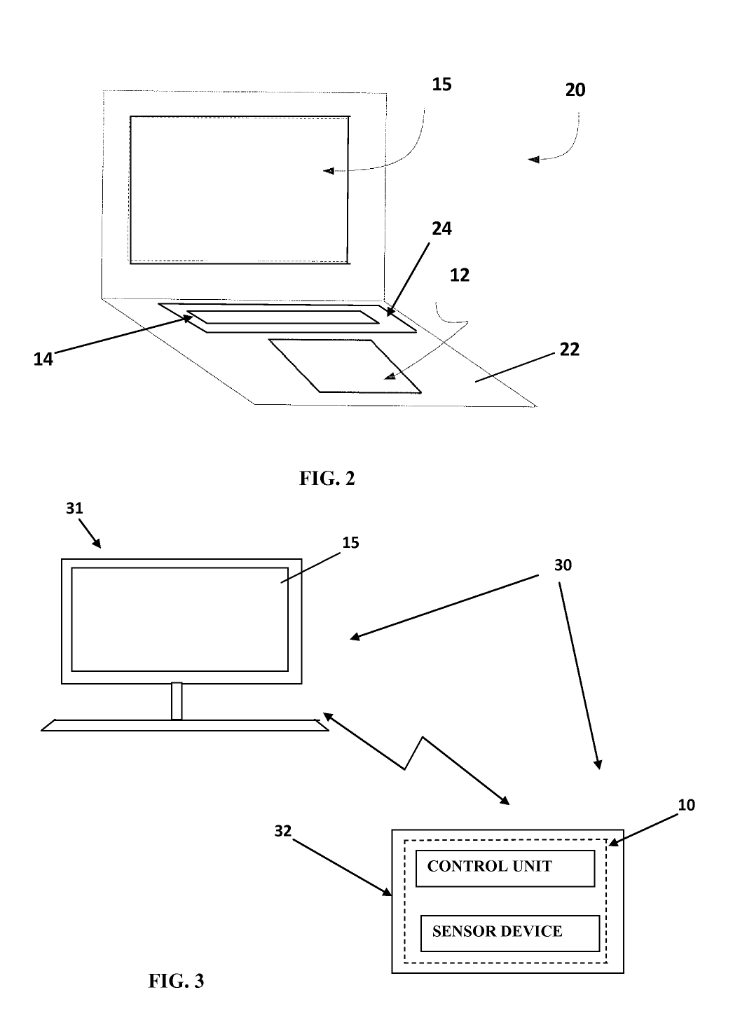

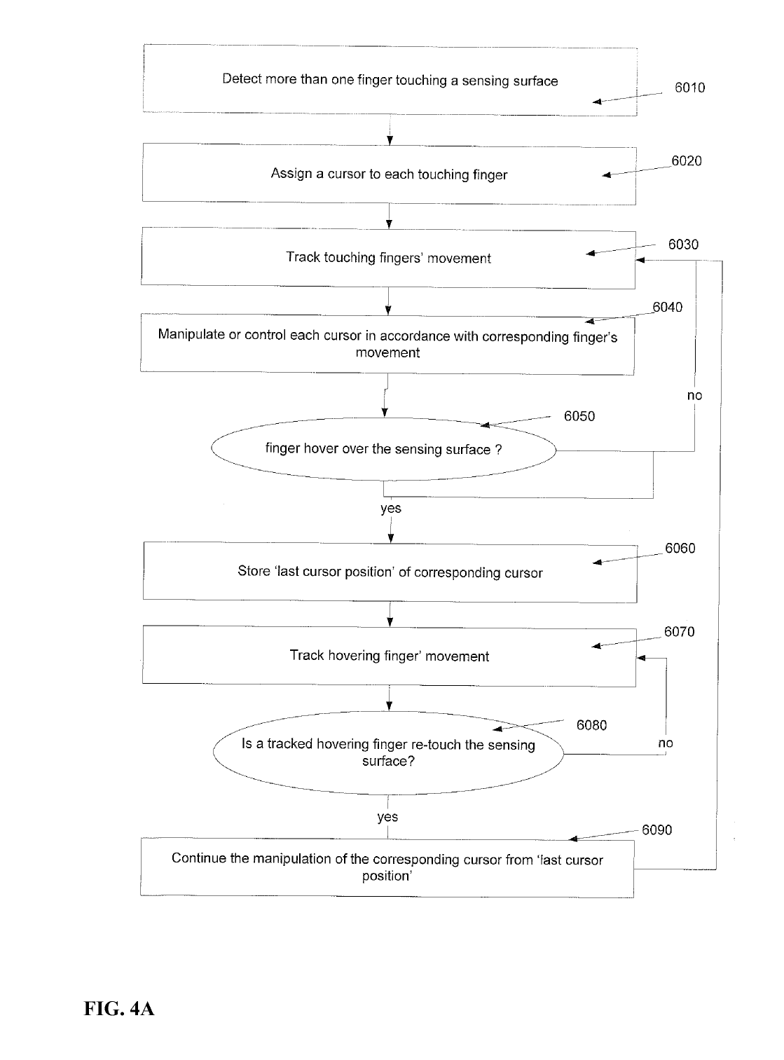

Reference is made to FIGS. 2 and 3 showing two specific but not limiting examples of the use of the above-described monitoring system 10. To facilitate understanding, the same reference numbers are used for identifying components that are common for all the examples.

FIG. 2 exemplifies a portable electronic device 20 such as a portable computer, phone device, etc. including a touchpad function. The device includes a data input panel 22, a data processor unit 24, a display 15 and incorporates the above described monitoring system 10 for monitoring behavior of multiple objects. The monitoring system 10 includes a sensor device 12 configured and operable as described above and incorporated in the touchpad panel of device 22, a control unit 14 configured and operable as described above and incorporated in the processor unit 24. The control unit 14 is configured as described above and is actually a program embedded in the processor 24 of device 20. It should be understood that for the purposes of the present invention, the sensor device 12 is either a conventional touchpad utility or a touchpad utility modified or replaced by a sensor device capable of sensing both touch and hover conditions of a plurality of objects. For that purpose, sensor device 12 may also use the camera embedded in or attached to portable device 20. The typical touchpad functions by utilizing a first sensing technique capable of 2D motion tracking of an object moving along the sensing surface in a contact fashion. Thus, a touchpad panel modified for the purposes of the present invention may incorporate a second sensing technique for 3D position sensing in a contactless fashion. The first and second sensing techniques may be implemented in a common proximity sensor device, where a zero distance (height) corresponds to the contact (touch) condition.

FIG. 3 illustrates an electronic system 30 incorporating a monitoring system 10 of the present invention. In the present example, electronic system 30 is configured as a TV set including inter alia a TV unit 31 including a display 15, and a remote control panel 32. The utilities of the monitoring system 10 of the present invention are distributed within the TV set units for controlling the multiple objects' behavior remotely from the objects' locations. The system 10 includes a proximity sensor matrix 12 which is integral with remote control panel 32, and a control unit 14.

The control unit 14 is configured as described above and its modules may be integral with the panel 32, or TV unit 31, or may be distributed between the units 31 and 32. Accordingly, appropriate communication ports (transmitter and receiver) and possibly also signal formatting modules are provided for communication between the system elements in the panel 32 and TV unit 31 via wires or wireless signal communication (e.g. RF, IR, Bluetooth, acoustic).

Thus, the device 20 or system 30 may operate in the following manner: The proximity sensor matrix 12 operates to track the physical object's movement (i.e. monitor the object's behavior) relative to a sensing surface of the sensor matrix 12 and generates sensing data (e.g., measured data) indicative thereof. The measure data is received at the data input utility of the control unit 14 which actuates the identifier utility to assign an image (cursor) to each object and manage the cursors appearance on the screen in accordance with the objects' behavior. This will be exemplified in more details further below.

The sensor matrix may be associated with an actuator (not shown) which is coupled to or associated with an AC power source. The AC power may be configured to operate with a certain frequency or frequency range. The actuator may be configured and operable to identify “noise” energy being in the same or overlapping frequency range and being originated by an external energy source. Upon identifying such a condition (existence of the noise energy), the actuator may either prevent operation of the sensor matrix or preferably operate to shift the operative frequency of the AC power source.

Reference is now made to FIG. 4A and FIG. 4B showing simplified flow charts describing two specific but not limiting examples of a method of the invention for manipulating and/or controlling a plurality of cursors on a display screen in accordance with some embodiments of the present invention. In some embodiments, one or more fingers (objects) interacting with (touching) a sensing surface is detected (step 6010) and a corresponding cursor is assigned to each touching finger (step 6020). As indicated above, the sensing surface may be associated with a touchpad-like unit of a laptop computer or the like (with a 3D function) that is used to manipulate a plurality of cursors on a display screen. The fingers may be detected by any method known in the art, e.g., by capacitive methods, resistive methods, optical methods etc. The touching fingers' movement on the sensing surface is tracked (step 6030). In some embodiments, as exemplified with reference to FIG. 4B, more than one finger touching or hovering over a sensing surface are detected (step 6011) and a corresponding cursor is assigned to each touching or hovering finger (step 6021). The cursors that correspond to hovering fingers may not be displayed on the display screen. The movement of the touching and hovering fingers is tracked (step 6031).

In some embodiments, a different icon and/or image (e.g., an arrow image) may be associated with each different cursor.

Each cursor is manipulated and/or controlled and/or operated by corresponding touching finger's movement (step 6040). Typically, the cursor is moved on the display screen in accordance with the corresponding finger's movement. The position of the fingers in a first coordinate system (e.g., which corresponds to the coordinate system of the sensing surface) may be translated to a position of the cursor in a second coordinate system (e.g., which corresponds to the coordinate system of the display screen). For example, if the finger was dragged in the last system cycle according to vector (x,y) along the sensing surface, its corresponding cursor is dragged on the display from its last location according to vector k(x,y), where k is some real factor.

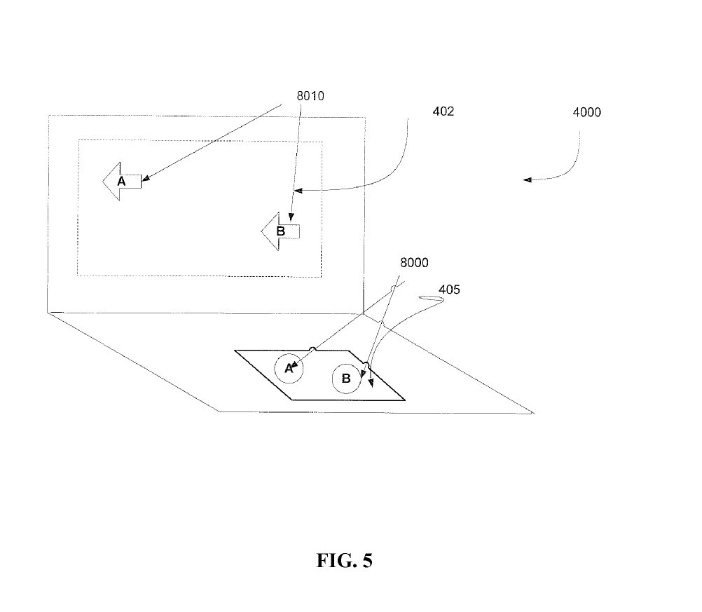

FIG. 5 illustrates a plurality of cursors manipulated on a display (e.g. that of a laptop computer) in accordance with an example of the present invention. A user may interact with the system using his finger over sensing surface of the sensor device 12, e.g., a touchpad. A plurality of fingers 8000 touch sensing surface 405 (e.g., finger A and B) and corresponding cursors 8010 (e.g., cursor A and B) are displayed on display 15. A location of the displayed cursors 8010 corresponds to a location of the corresponding fingers 8000 on the sensing surface 12. The location of the displayed cursors 8010 may move and/or change in accordance with a movement (e.g., location change) of the corresponding fingers 8000 on the sensing surface 12.

The control unit 14 associated with the sensor device 12 may be configured to transmit users' related information (data), e.g., position of the cursor in a second coordinate system (e.g., display screen coordinate system) and/or position of the fingers in a first coordinate system (e.g., sensing surface coordinate system) and/or a delta value from last position of the cursor and/or finger, to a memory utility.

Typically, the user performs a sequence of “drag and lift” procedures (lifting is typically done at the end of the touch area) in order to drag objects along the sensing surface and thus drag the cursors on the display. As will be described, keeping tracking of each finger even after it was lifted from the touch area (after a break of contact), allows for keeping the assignment to its corresponding cursor.

Referring back to FIGS. 4A and 4B, in some embodiments, the identifier operates to determine whether a touching finger was lifted and/or raised from the sensing surface and is now hovering above the sensing surface (step 6050). If no finger was lifted and/or raised from the sensing surface (step 6050: NO), then the method returns to step 6030. If one or more fingers were lifted (e.g., lifted fingers) from the sensing surface (step 6050: YES), then a ‘last cursor position’ corresponding to each of the lifted fingers may be stored and/or recorded, e.g. in a memory 14C (step 6060). It should be noted, that the movement of the rest of the fingers which are touching the sensing surface is tracked (step 6030) and the corresponding cursors are manipulated (step 6040). The location of the cursor of the lifted finger does not change.

In some embodiments, a movement of each one of the one or more lifted fingers (i.e., which are now hovering fingers) may be still tracked (step 6070) in order to keep the assignment to their corresponding cursors. As mentioned, this tracking might use data from a different sensor than the one used in 6030 (e.g. camera). One or more hovering fingers may no longer be detected by the sensing surface, for example when the finger is placed in a position outside the sensing zone of the given sensor device. When a hovering finger is no longer detected by the sensing surface, the corresponding ‘last cursor position’ is deleted, e.g., from memory and its corresponding cursor disappears from the screen.

Then the identifier utility operates to determine whether one or more of the tracked hovering fingers (e.g., which correspond to a previous touching finger) re-touch the sensing surface (step 6080). If no tracked hovering finger re-touches the sensing surface (step 6080: NO), then the method returns to step 6070. If one or more of the tracked hovering finger re-touches the sensing surface (step 6080: YES), then the corresponding cursor is assigned to the re-touching finger from ‘last cursor position’ of that cursor and is continued to be manipulated (step 6090) and the method returns to step 6030. It should be noted, that if one or more fingers are still hovering over the display screen, steps 6070 and 6080 are performed until all tracked hovering fingers have re-touched the sensing surface or are no longer detected by the sensing surface.

In this manner, a user is capable of operating a plurality of cursors on a display screen in a similar manner that a single cursor is operated, e.g., when the finger moves on a sensing surface and reaches the end of the surface, the finger is lifted and when re-touching the sensing surface, the cursor continues to move from last position before the lifting. In some embodiments, as the lifted fingers are tracked when hovering over the sensing surface, the device is capable of assigning the corresponding cursor when a finger re-touches the sensing surface.

It should be noted (although not illustrated), that during operation, one or more fingers may be added and additional cursors may be assigned. For example, at the beginning two fingers (A and B) may touch the sensing surface and two cursors (A and B) may appear on the display, an additional finger (C) may touch the sensing surface which may result in three cursors (A, B and C) appearing on the display.

In another example, at the beginning two fingers (A and B) may touch the sensing surface and two cursors (A and B) may appear on the display, one of the fingers (e.g., finger A) may be lifted from the sensing surface and its last position may be stored, hovering finger (finger A) and touching finger (finger B) are now tracked while only cursor B is currently manipulated on the display. An additional finger (C) may touch the sensing surface which may result in two cursors (B and C) appearing on the display. When finger A re-touches the display screen, cursor A may be manipulated from its last position which was stored.

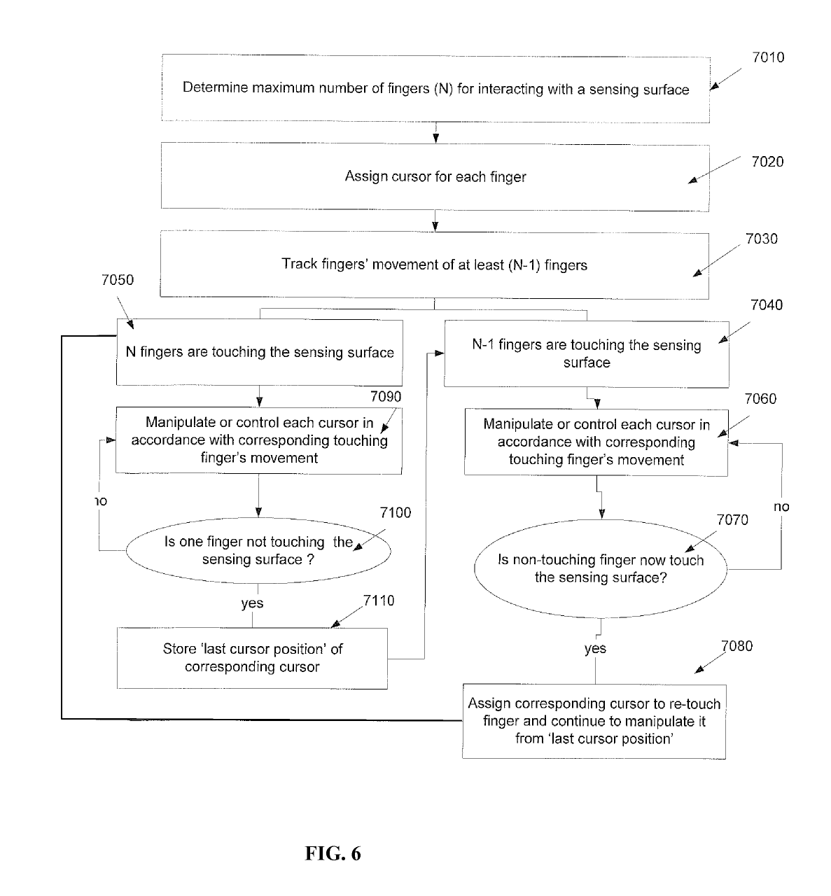

Reference is now made to FIG. 6 showing a simplified flow chart describing an exemplary method for manipulating and/or controlling a plurality of cursors on a display screen in accordance with some embodiments of the present invention. The method exemplified in FIG. 6 may be employed in a sensing surface only capable of detecting touching fingers.

In some embodiments, a maximum number of fingers (N) operable and/or allowable and/or permitted to interact with a sensing surface is determined (step 7010).

The maximum number of fingers (N) may be system defined or user defined. For example, the maximum number of fingers (N) may be in the range of 2-10, e.g. 2, 3, or 4. The maximum number of fingers (N) corresponds to a maximum number of cursors (N) which are assigned to each finger (step 7020).

In some embodiments, during operation, at least N−1 fingers are touching (e.g., interacting with) the sensing surface and their movement is tracked (step 7030).

During operation, two scenarios (or modes) are permitted and/or allowable:
(1) N−1 fingers are touching (e.g., interacting with) the sensing surface (denoted as 7040 in FIG. 6)
(2) N fingers are touching (e.g., interacting with) the sensing surface (denoted as 7050 in FIG. 6)

In some embodiments, each cursor (e.g., N cursors in accordance with scenario/mode 7050 or N−1 cursors in accordance with scenario/mode 7040) may be manipulated and/or controlled and/or operated by corresponding touching finger's movement (step 7060 or 7090). Typically, the cursor may be moved on the display screen in accordance with the corresponding finger's movement. The position of the fingers in a first coordinate system (e.g., which corresponds to the coordinate system of the sensing surface) may be translated to a position of the cursor in a second coordinate system (e.g., which corresponds to the coordinate system of the display screen).

During operation, when N fingers are touching the sensing surface and corresponding N cursors are manipulated (corresponds to scenario/mode 7050), a query is made to determine whether one finger is not touching the sensing surface (step 7100), e.g., that one finger was lifted from the sensing surface. If no finger was lifted from the sensing surface (step 7100: NO), e.g., N fingers are touching the sensing surface, the method returns to step 7090. If one finger was lifted from the sensing surface (step 7100: YES), e.g., N−1 fingers are touching the sensing surface, a ‘last cursor position’ of the touching finger may be recorded and/or stored, e.g., in a memory (step 7110) and the method moves to mode 7040. The hovering finger may not be tracked when hovering above the sensing surface.

During operation, when N−1 fingers are touching the sensing surface and corresponding N−1 cursors are manipulated (corresponds to scenario/mode 7040), a query is made to determine whether an additional finger (non-touching finger) now touch the sensing surface (step 7070). If no additional finger is touching the sensing surface, (step 7070: NO), e.g., N−1 fingers are touching the sensing surface, the method returns to step 7060. If an additional finger is now touching the sensing surface, (step 7070: YES), e.g., N fingers are touching the sensing surface, a corresponding cursor (the one that is not manipulated) may be assigned to the additional finger in the ‘last cursor position’ that is recorded and/or stored and the cursor is continued to be manipulated (step 7080) and the method moves to mode 7050.

In this manner, a user may operate a plurality of cursors on a display screen in a similar manner that a single cursor is operated.

In some embodiments, a different icon and/or image (e.g., an arrow image) may be associated with each different cursor. The user may be able to select and/or choose the different icon and/or image associated with the different cursors. For example, detecting the presence of a finger touching or hovering above the detection surface may invoke a display of a selection box including a plurality of icons and/or images from which the user may be able to select an icon or image for the cursor. In some embodiments, a different color may be associated with each different cursor (e.g., the image associated with each different cursor may be identical but colored differently).

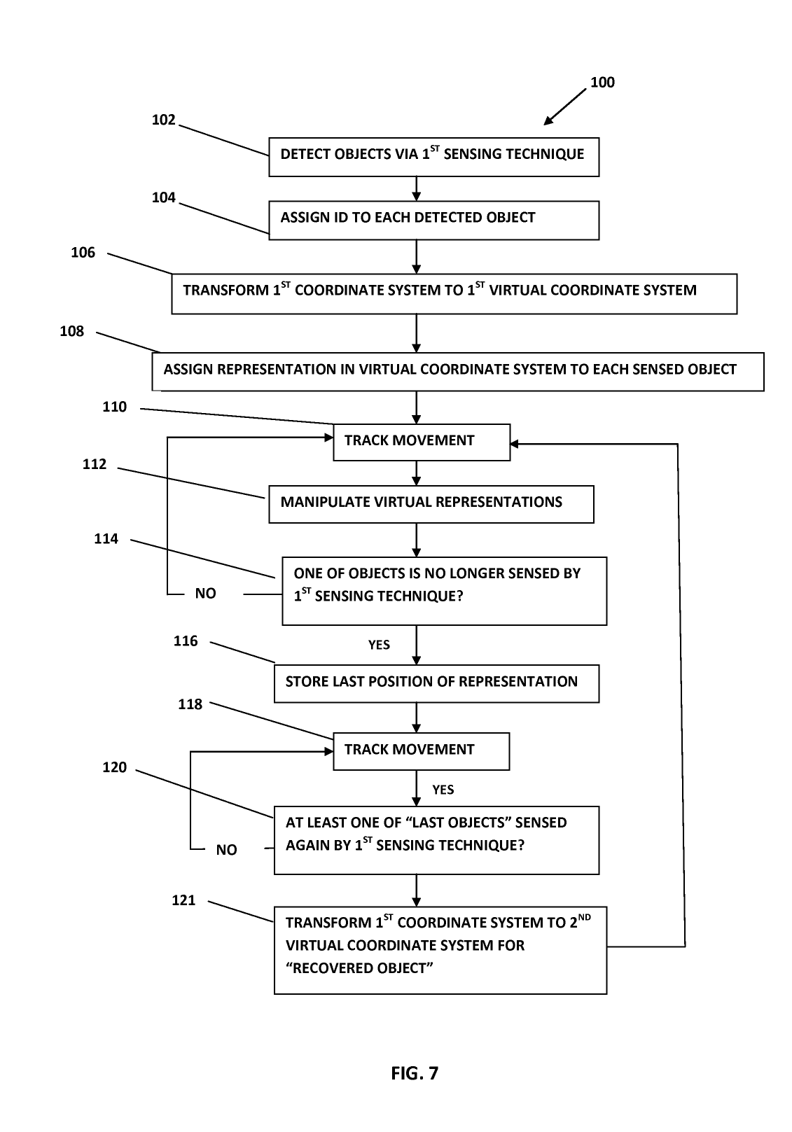

Reference is now made to FIGS. 7 to 9 showing some more specific but not limiting examples of the technique of the present invention. With reference to FIGS. 7-9 below, it should be understood that the term “first sensing technique” used in the description of these examples corresponds to the “touch sensing” mentioned above. The term “second sensing technique” corresponds to the 3D sensing function of the sensor device (hover sensing) as described above. The expression “virtual coordinate system” refers the coordinate system of the display device. The expression “representation of the object” refers to the image of the object or virtual object as mentioned above.

FIG. 7 shows a flowchart 100 illustrating an example of a method for monitoring the behavior of a plurality of object simultaneously.

At 102, a first group of objects is detected in a first coordinate system according to at least a first sensing technique. Such first sensing technique may be, for example, a touch sensing technique performed by a touch sensor or a touch sensor array. Each of the objects detected via the first sensing technique is also sensed via a second sensing technique. The second sensing technique is configured for sensing objects that cannot be sensed by the first sensing technique. In a variant, the second sensing technique is, for example, a proximity sensing technique, for sensing an object hovering over a sensing surface. In another variant, the second sensing technique is, for example, an optical sensing technique, in which images or video of the object is/are taken and the object is identified via image processing. At 104, each of the objects sensed according to the first sensing technique is identified. The identification may be performed by processing data generated via the first sensing technique (for example, touch sensing), the second sensing technique, or both. In an embodiment of the present invention, the second sensing technique is used in order to identify each of the objects. Each of the objects is therefore assigned an ID. According to a non-limiting example, the identification of the object is made by receiving data generated by a proximity sensor and processing such data according to an “object independent” processing scheme using the HMM (Hidden Markov Model) or “an object dependent” processing scheme utilizing a learning session of features values of the specific user whose behavior is being monitored. Both such schemes are described in detail in U.S. application Ser. No. 13/190,935 assigned to the assignee of the present patent application.

At 106, a transformation is performed, in which the first coordinate system is transformed to a second virtual coordinate system. At 108, each object detected according to the first sensing technique is assigned a representation in the virtual coordinate system. The virtual coordinate system may be, for example, a scene displayed in a display device. The representation of the object may be a cursor in the scene. Optionally, all cursors look the same. Alternatively, each cursor may have a unique shape and/or color.

At 110, the movement of all the objects sensed via the first technique is tracked, and at 112, each representation of each object is manipulated in the virtual coordinate system, according to the tracked movement of the corresponding objects.

At 114, a check is made to determine whether at least one of the above-mentioned objects is no longer sensed via the first sensing technique. For example, if the first sensing technique is a touch-sensing technique, an object no longer touching the sensing surface is no longer detected by the touch sensor.

If all of the objects of the first group are still sensed via the first sensing technique, then a loop is created, returning to the step 110, in which the movement of all the objects sensed via the first technique is tracked.

If, on the contrary, at least one of the objects of the first group is no longer sensed via the first sensing technique, the last virtual position of the object's representation in the virtual coordinate system is stored at 116.

At 118 the movement of all the objects is tracked. The objects sensed via the first sensing technique may be tracked via the first and/or second sensing technique. The objects sensed only via the second technique are tracked via the second sensing technique. It should be noted that the representations of the objects sensed by the second technique alone are not manipulated. Therefore, in an example, if the first sensing technique is touch-sensing and the second technique is proximity-sensing (i.e. hover sensing), then the movement of objects that touch the sensing surface of the proximity sensor is tracked and used for manipulating the corresponding virtual representations. The objects that hover over the sensing surface are tracked by a proximity sensor only for the purpose of determining their position and keeping their IDs. The movement of the hovering objects is not used for manipulation of the corresponding representations.

At 120, a query is performed to determine whether objects that were previously lost to the first sensing technique are again sensed via the first sensing technique. Keeping in line with the above non-limiting example, the check is used to determine whether one of the hovering objects has again touched the sensing surface of the touch sensor.

If the answer to the query is no, then the process returns to step 118, in which the objects sensed via the first sensing technique are be tracked via the first and/or second sensing technique while the objects sensed only via the second technique are tracked via the second sensing technique.

On the contrary, if at least one of the objects that were lost to the first sensing technique is again recovered by the first sensing technique, then for each “recovered object” a transformation is performed from the first coordinate system to a respective new virtual coordinates system at 121. Each of the respective new virtual coordinate systems is constructed or selected from a predetermined number of options in order to match the new position of each “recovered object” in the first coordinate system to the last virtual position of the each object's representation system stored at 116.

Consequently, a loop is created, to return to step 110, in which the movement of all the objects sensed via the first technique is tracked, in order to manipulate the respective representations.

The above-described method may be used, for example, in a pointing utility having two distinct sensing units, such as a touch sensor and a proximity sensor, or a touch sensor and an optical sensor including a camera, or even a proximity sensor having a certain range and an optical sensor having a greater range. In another example, the configuration may be such that the same sensor unit will support both sensing techniques. For example, proximity sensor which allows for distinguishing between touch and hover (for example according to values of measured amplitudes). The above-described method may utilize a condition that at the beginning of the monitoring/controlling procedure all of the objects of interest (i.e. objects the behavior of which is to be monitored) are sensed via the first and second sensing techniques.

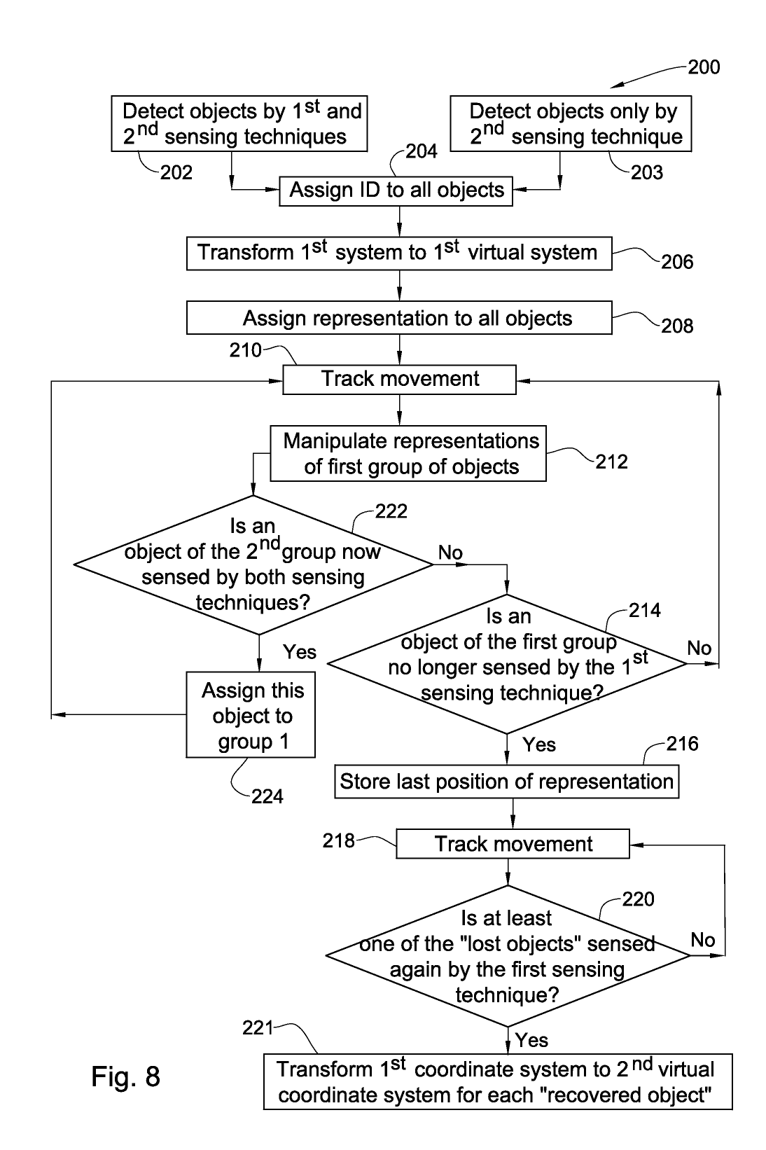

FIG. 8 shows a flowchart 200 illustrating another example of a method 200 for monitoring the behavior of a plurality of objects simultaneously.

At 202, a first group of objects is detected in a first coordinate system according to a first sensing technique and a second sensing technique (for example, touch sensing and proximity-sensing, or touch-sensing and optical sensing, or proximity sensing and optical sensing), in which the second sensing technique is configured for sensing objects that cannot be sensed by the first sensing technique. At 203, a second group of objects is detected via the second sensing technique alone, as they are out of range at which they can be sensed by the first sensing technique.

At 204, each of the objects of the first and second groups is identified and assigned a unique ID, as described with reference to the step 104 of FIG. 7.

At 206, a transformation is performed, in which the first coordinate system is transformed to a first virtual coordinate system. At 208, detected object is assigned a representation in the virtual coordinate system. Optionally, all cursors look the same. Alternatively, each cursor may have a unique shape and/or color. In a variant, all cursors corresponding to objects sensed via the first sensing technique are represented in a first manner, while all the cursors corresponding to objects sensed via the second sensing technique are represented in a second manner. Optionally, only cursors corresponding to objects sensed via the first sensing technique are to be displayed, while cursors corresponding to objects sensed via the second sensing technique are not to be displayed until the respective object is also sensed via the first sensing technique.

Steps 210 to 221 are analogous to the steps 110 to 121 described in FIG. 7. Before the step 214 (a check to determine whether at least one of objects of the first group is no longer sensed via the first sensing technique), another check 222 is performed. At 222, a check is performed to determine whether any of objects belonging the second group are now also detected via the first sensing technique. If such is the case, then the object or objects of the second group that can now be detected also via the first sensing technique are transferred to the first group at 224, and a loop is created to return the process to step 210, in which the movement of all objects is tracked, and the tracking of objects in the first group is used for manipulating the corresponding representations. If no object belonging the second group is now detected via the first sensing technique, the process continues to the query 214, which is analogous to the query 114 of FIG. 7.

Like the method 100 of FIG. 7, the method 200 may also be used, for example, in a pointing utility having two distinct sensing units, such as a touch sensor and a proximity sensor, or a touch sensor and an optical sensor including a camera, or even a proximity sensor having a certain range and an optical sensor having a greater range. The method 100 is generally for use when at the beginning of the method, at least some of the objects of interest (i.e. objects the behavior of which is to be monitored) are sensed only by the second sensing techniques.

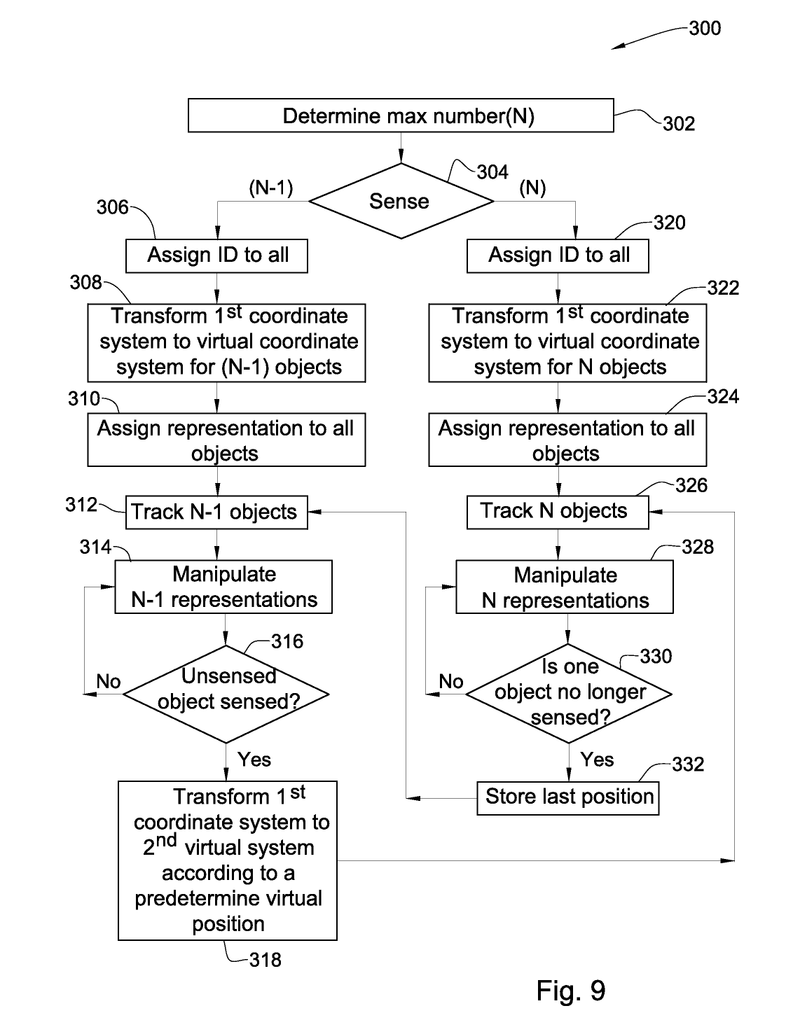

Reference is now made to FIG. 9 showing a flowchart 300 describing a method for monitoring the behavior of a plurality of objects simultaneously. The method 300 may be employed in a pointing utility having a sensor capable of detecting object via a single detection technique (for example touch-based only).

At 302, a number (N) of objects operable and/or allowable and/or permitted to interact with a sensing surface for a particular application is determined. The maximum number of objects may be system defined (for example defined by the technical features of the pointing device, and/or of the electronic device controlled via the pointing device, and/or by the properties of a particular application running on said electronic device) or user defined. For example, if the objects are fingers, the maximum number of fingers (N) may be in the range of 2-10, e.g. 2, 3, or 4.

Once the number N is defined, the objects are detected by the pointing utility at 304. It should be noticed that the number of detected objects is either N or N−1. If, for example, a different number is detected, the pointing device, electronic device, or application will not respond to the user's commands given to/via the pointing device.

Following the path in which N−1 objects are detected, IDs are assigned to all the objects (the N−1 detected objects and the one undetected object), at 306. At 308, the first coordinate system defined by the pointing utility's sensing unit is transformed to a first virtual coordinate system. At 310, a representation of each of the object (whether sensed or unsensed) in the virtual coordinate system is assigned to the respective object. In one embodiment, the representation of the unsensed object is not to be displayed until the unsensed object is sensed by the pointing utility's sensing unit. As mentioned above, the representation may be a cursor. The cursors may have the same or different shapes and/or colors.

At 312, the movement of each of the N−1 sensed objects is tracked via interaction of the sensed objects with the sensing unit of the pointing utility. At 314, the movement tracking of 310 is used in order to manipulate the N−1 representations of the N−1 sensed objects.

At 316, a check is performed to determine whether the unsensed object is now sensed by the sensing unit of the pointing utility. If the unsensed object is still not sensed, the manipulation of the N−1 representations is performed as before in 314. If, on the other hand, the previously unsensed object is now sensed, a transformation of the first coordinate system to a second virtual system is performed at 318, in order to match the position of the previously unsensed object in the first coordinate system to a virtual position of the representation corresponding to the previously unsensed object. It should be noted that the virtual position of the representation corresponding to the previously unsensed object is a predetermined position. Such predetermined position may be a stored last position (if present), or may be dependent on the position of the other objects. After the transformation of 318, all N objects are tracked at 326, which will be explained below.

If at the sensing step 304, N objects are detected, each of the N objects is assigned unique IDs at 320, and a transformation is made between the first coordinate system to a virtual coordinate system for all N objects at 322. At 324, each object is assigned its representation. At 326, the movement of all N objects is tracked. The movement tracking of 326 is then used in step 328 in order to manipulate the N representation. At 330, a check is made to determine whether one of the N sensed objects is no longer sensed. If so, the last virtual position in the virtual coordinate system of the representation of the now unsensed object is stored at 322, and the tracking of only N−1 objects is preformed at 312. If all N objects are still sensed, the manipulation of N object representations in the virtual coordinate system goes on at 328.

It should be noted that although embodiments of the present invention were described in the context of manipulating a plurality of cursors by finger touch on a sensing surface, embodiments of the present invention may be implemented for manipulating a plurality of cursors by any other user interaction detected on a sensing surface, e.g., a stylus. For example, a plurality of styli may be detected on a sensing surface and used to manipulate a plurality of cursors on a display screen.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1. A method for use in controlling images on a screen, the method comprising:
identifying each object from multiple touching objects with respect to a sensing surface, and assigning a dedicated image to each of the identified objects for presentation on a screen, assignment of the object to its corresponding dedicated image being kept when the object returns from a no contacting state to contacting state;
sensing behavior of each of the multiple objects, said sensing comprising: monitoring a position of the object contacting the sensing surface and generating position data indicative thereof, and selectively identifying a break in contact between a contacting object and the sensing surface and generating data indicative thereof;
processing the position data for each of the contacting objects and generating transformation data between the first coordinate system of the sensing surface and a virtual coordinate system of the screen, and selectively generating and storing data indicative of a last position in the virtual coordinate system of the images corresponding to the contacting objects, when said contacting objects breaks contact with the sensing surface;
using said transformation data for controlling the image associated with each contacting object on the screen.

2-3. (canceled)

4. The method of claim 1, wherein the objects are fingers of one or two hands of a user.

5. The method of claim 1, wherein:
said sensing comprises detecting one or more hovering objects, that have broken contact with the sensing surface, in a vicinity of the sensing surface; and
said controlling comprises manipulating the image associated with a hovering object from the last position, when the hovering object returns to the contacting state and re-touches the sensing surface.

6. The method of claim 1, comprising monitoring a movement of each user's finger from a plurality of fingers touching the sensing surface and controlling movement of each of a plurality of corresponding images on the screen in accordance with the fingers' movement.

7. The method of claim 1, wherein said sensing is carried out substantially simultaneously for the multiple identified objects.

8. A method for controlling a plurality of images on a screen corresponding to a plurality of objects, the method comprising:
identifying each object from the plurality of contacting and hovering objects with respect to a sensing surface, and assigning to each object a dedicated image for presentation on a screen, the assignment of each hovering object to its dedicated image being preserved when the hovering object returns to a contacting state;
substantially simultaneously sensing behavior of the objects with respect to the sensing surface, said sensing comprising: monitoring a position of each of the objects contacting the sensing surface in a first coordinate system of the sensing surface and generating position data indicative thereof; selectively detecting a hovering object in a vicinity of the sensing surface and generating data indicative thereof when a break in contact between said contacting object and the sensing surface occurs,
processing and analyzing the position data for the contacting objects and generating transformation data between a first coordinate system of the sensing surface and a virtual coordinate system of the screen, and selectively generating and storing data indicative of a last position in the virtual coordinate system of images corresponding to the contacting objects respectively, when said contacting objects break contact with the sensing surface; and
using said transformation data for manipulating images on the screen for each of the contacting objects.

9. A system for monitoring behavior of multiple objects, the system comprising:
a sensor device, the sensor device being configured and operable to carry out a first sensing mode to determine a position of each of the multiple objects touching a sensing surface of said sensor device in a first coordinate system of the sensor device, and generate first position data indicative of a position of the touching objects in said first coordinate system, said sensor device being configured and operable to selectively carry out a second sensing mode to detect hovering objects in a vicinity of the sensing surface and generate second data indicative thereof;
a control unit comprising:
an identifier utility configured and operable for carrying out the following: identifying touching and hovering objects with respect to the sensing surface, and assigning a dedicated image to the identified object for presentation on a screen; analyzing the data generated by the sensor device and identifying a break in contact between said touching object and the sensing surface;
a memory utility for storing last position of the images assigned to the hovering objects before the hovering objects broke contact with the sensing surface;
a transformation utility configured and operable for processing the position data for the contacting objects and generating transformation data between a first coordinate system of the sensing surface and a virtual coordinate system of the screen, thereby enabling to use said transformation data for controlling images on the screen for each of the contacting objects, said transformation of the position data including data indicative of a last position for the hovering objects in the virtual coordinate system before the contact break with the sensing surface.

10. The system of claim 9, wherein said sensing device comprises a single proximity sensing unit defining the sensing surface and configured and operable for carrying out both the first and the second sensing.

11. The system of claim 9, wherein said sensing device comprises a first sensing unit defining the sensing surface and configured and operable for detecting objects touching said sensing surface, and a second sensing unit configured and operable for detecting at least hovering objects.

12. The system of claim 9, wherein said sensing surface is selected from the following: a capacitive sensing surface, a resistive sensing surface, a surface acoustic waves sensing surface, and an optical sensing surface.

13. The system of claim 9, further comprising a screen device defining a virtual coordinate system and configured and operable for receiving the transformation data and presenting the images of the objects.

14. A control system for controlling multiple images on a screen each image corresponding to a remote object, the system comprising:
the monitoring system of claim 9; and
a screen device defining the virtual coordinate system and connectable to the monitoring system, the screen device being configured and operable for receiving the transformation data from the monitoring system, and presenting the corresponding images.
